(19) United States
(12) Patent Application Publication
(10) Pub. No.: US 2023/0264452 A1
(43) Pub. Date: Aug. 24, 2023

(54) HEAT INSULATION AND PRESERVATION COMPOSITE BOARD AND PREPARATION METHOD THEREOF

(71) Applicant: GONG YI VAN-RESEARCH INNOVATION COMPOSITE MATERIAL CO. LTD, Gongyi City (CN)

(72) Inventors: Dongsheng ZHANG, Zhengzhou (CN); Huina DONG, Zhengzhou (CN); Dongjia YAO, Zhengzhou (CN); Xizong LIU, Zhengzhou (CN); Duojun LV, Zhengzhou (CN); Jicheng ZHANG, Zhengzhou (CN); Qiyong YU, Zhengzhou (CN); Heng WU, Zhengzhou (CN); Hongxia YANG, Zhengzhou (CN)

(21) Appl. No.: 18/016,135

(22) PCT Filed: Jul. 6, 2021
(86) PCT No.: PCT/CN2021/104761

§ 371 Date: Jan. 13, 2023

(30) Foreign Application Priority Data
Jul. 13, 2020 (CN) 202010670382.4

(51) Int. Cl. B32B 5/24; B32B 5/02; B32B 15/04; B32B 5/18; B32B 13/04; B32B 9/04; B32B 7/12; B32B 15/20; B32B 3/04

(52) U.S. Cl. CPC B32B 5/245; B32B 5/02; B32B 15/046; B32B 5/18; B32B 13/045; B32B 9/046; B32B 7/12; B32B 15/20; B32B 3/04; B32B 2255/26; B32B 2307/304; B32B 2262/101; B32B 2262/106; B32B 2262/105; B32B 2262/0269; B32B 2262/0253; B32B 2266/126; B29C 70/42

(57) ABSTRACT

A heat insulation and preservation composite board includes a first panel layer and a heat insulation and preservation layer. The heat insulation and preservation layer and the first panel layer are integrally formed. The first panel layer is a fiber-reinforced resin-based composite sheet, a metal plate, a cement plate, a calcium silicate plate, or a gypsum plate. The heat insulation and preservation layer is a fiber-reinforced aerogel felt. A preparation method of the heat insulation and preservation composite board includes: (1) laying the fiber-reinforced aerogel felt flat; (2) laying the first panel layer flat on the upper surface of the fiber-reinforced aerogel felt; (3) performing a hot-press molding process to obtain the heat insulation and preservation composite board.

### TECHNICAL FIELD

The present disclosure relates to the technical field of heat insulation and preservation, and particurlarly to a heat insulation and preservation composite board and a preparation method thereof.

### BACKGROUND

An aerogel is a porous material with a nano-scale pore size, typiclly between 1 nm and 100 nm, and a porosity of 80% or more, which contains a large amount of air inside. The nano porous structure of the aerogel makes the thermal conductivity of the material extremely low, which results in a good heat insulation and preservation effect.

The aerogel has a certain brittleness and a poor strength for direct use due to its low specific gravity and thin pore wall. Nowadays, the industrialized aerogel products include aerogel fabrics, aerogel papaers, aerogel boards, aerogel felts, and other aerogel special parts. Generally, an aerogel composite material is used as a protective material for a sandwich structure due to its unique heat insulation and preservation property. The sandwich structure board typically includes panel layers and a core layer. Such a structure has great advantages of high deformability and adaptability, strong impact resistance, large size, good heat insulation effect, and simple assembly, which solves the shortcomings of the traditional external heat insulation material of high brittleness and falling powder, improves the design margin and the safety and environmental protection properties, and has been widely used in the heat preservation of pipelines, building walls, vehicles, and boxes/cabinets.

### SUMMARY

The present disclosure aims to provide a heat insulation and preservation composite board and a preparation method thereof.

To achieve the above purposes, the present disclosure provides technical solutions as follows.

A heat insulation and preservation composite board includes a first panel layer and a heat insulation and preservation layer. The heat insulation and preservation layer and the first panel layer are integrally formed. The first panel layer is selected from the group consisting of a fiber-reinforced resin-based composite sheet, a metal plate, a cement plate, a calcium silicate plate, and a gypsum plate. The heat insulation and preservation layer is a fiber-reinforced aerogel felt.

In a case that the first panel layer is the fiber-reinforced resin-based composite sheet, a surface of the fiber-reinforced aerogel felt which is in contact with the first panel layer is coated or uncoated with a heat insulation coating.

In a case that the first panel layer is selected from the group consisting of the metal plate, the cement plate, the calcium silicate plate, and the gypsum plate, the surface of the fiber-reinforced aerogel felt which is in contact with the first panel layer is coated with the heat insulation coating.

The heat insulation coating consists of a liquid epoxy resin, a heat insulation filler, a curing agent, an enhancer, and a first coupling agent in a mass ratio of 100:(10-50):(20-180):(0.05-3):(0.2-5). Alternatively, the heat insulation coating consists of an aqueous elastic paint, an aqueous resin, a flame retardant, silicon dioxide powder, a dispersing agent, and a second coupling agent in a mass ratio of (30-60):(10-30):(2-5):(5-40):(0.5-5):(1-5).

Based on the above-described technical solutions, in some embodiments, the heat insulation and preservation composite board includes a second panel layer. The heat insulation and preservation layer is located between the first panel layer and the second panel layer. The heat insulation and preservation layer and the second panel layer are also integrally formed. The second panel layer is an additional fiber-reinforced resin-based composite sheet. The surface of the fiber-reinforced aerogel felt which is in contact with the first panel layer and another surface of the fiber-reinforced aerogel felt which is in contact with the second panel layer are each coated or uncoated with the heat insulation coating.

Based on the above-described technical solutions, in some embodiments, the fiber-reinforced aerogel felt is externally and directly wrapped by an aluminum foil in a case that the fiber-reinforced aerogel felt is uncoated with the heat insulation coating, or externally wrapped by an aluminum foil after being coated with the heat insulation coating in a case that the fiber-reinforced aerogel felt is coated with the heat insulation coating. A bonding agent or a double faced adhesive tape is provided between the aluminum foil and the first panel layer or between the aluminum foil and the second panel layer, so that the aluminum foil is attached to the first panel layer or the second panel layer.

Based on the above-described technical solutions, in some embodiments, the heat insulation coating is replaced by a double faced adhesive tape.

A method for preparing the heat insulation and preservation composite board, includes:

(1) laying the fiber-reinforced aerogel felt flat;

(2) laying the first panel layer flat on the surface of the fiber-reinforced aerogel felt to be in contact with the first panel layer; in a case that the first panel layer is the fiber-reinforced resin-based composite sheet, and that the surface of the fiber-reinforced aerogel felt to be in contact with the first panel layer is coated with the heat insulation coating, the first panel layer in this step is directly the fiber-reinforced resin-based composite sheet or is replaced by a fiber-reinforced resin-based pre-preg tape corresponding to the fiber-reinforced resin-based composite sheet; in a case that the first panel layer is the fiber-reinforced resin-based composite sheet, and that the surface of the fiber-reinforced aerogel felt to be in contact with the first panel layer is uncoated with the heat insulation coating, the first panel layer in this step is replaced by a fiber-reinforced resin-based pre-preg tape corresponding to the fiber-reinforced resin-based composite sheet;

(3) performing a hot-press molding process to obtain the heat insulation and preservation composite board.

Based on the above-described technical solutions, in some embodiments, the heat insulation and preservation composite board includes a second panel layer. The heat insulation and preservation layer is located between the first panel layer and the second panel layer. The heat insulation and preservation layer and the second panel layer are also integrally formed. The second panel layer is an additional fiber-reinforced resin-based composite sheet. Both the surface of the fiber-reinforced aerogel felt which is in contact with the first panel layer and another surface of the fiber-reinforced aerogel felt which is in contact with the second panel layer are coated or uncoated with the heat insulation coatings. The corresponding step (2) includes: laying the first panel layer and the second panel layer flat on the surfaces of the fiber-reinforced aerogel felt to be in contact therewith, respectively. In a case that the first panel layer and the second panel layer are the fiber-reinforced resin-based composite sheets, and that the surfaces of the fiber-reinforced aerogel felt to be respectively in contact with the first panel layer and the second panel layer are coated with the heat insulation coatings, the first panel layer and the second panel layer in this step are directly the fiber-reinforced resin-based composite sheets or are replaced by fiber-reinforced resin-based pre-preg tapes corresponding to the fiber-reinforced resin-based composite sheets. In a case that the first panel layer and the second panel layer are the fiber-reinforced resin-based composite sheets, and that the surfaces of the fiber-reinforced aerogel felt to be respectively in contact with the first panel layer and the second panel layer are uncoated with the heat insulation coatings, the first panel layer and the second panel layer in this step are replaced by fiber-reinforced resin-based pre-preg tapes corresponding to the fiber-reinforced resin-based composite sheets. In a case that the first panel layer is selected from the group consisting of the metal plate, the cement plate, the calcium silicate plate, and the gypsum plate, that the second panel layer is the fiber-reinforced resin-based composite sheet, and that the surfaces of the fiber-reinforced aerogel felt to be respectively in contact with the first panel layer and the second panel layer are coated with the heat insulation coatings, the second panel layer in this step is directly the fiber-reinforced resin-based composite sheet or is replaced by the fiber-reinforced resin-based pre-preg tape corresponding to the fiber-reinforced resin-based composite sheet.

Based on the above-described technical solutions, in some embodiments, the fiber-reinforced aerogel felt is externally and directly wrapped by an aluminum foil in a case that the fiber-reinforced aerogel felt is uncoated with the heat insulation coating, or externally wrapped by an aluminum foil after being coated with the heat insulation coating in a case that the fiber-reinforced aerogel felt is coated with the heat insulation coating.

Based on the above-described technical solutions, in some emobdiments, the heat insulation coating is replaced by a double faced adhesive tape.

In some embodiments, a temperature of the hot-press molding process is 50° C. to 150° C. A pressure of the hot-press molding process is 0.5 MPa to 5 MPa.

In the present disclosure, in a case that the first panel layer and/or the second panel layer is the fiber-reinforced resin-based composite sheet, the first panel layer or the second panel layer in the step (2) can be replaced by the fiber-reinforced resin-based pre-preg tape which is a semi-finished product of the fiber-reinforced resin-based composite sheet, as the fiber-reinforced resin-based pre-preg tape is cured into the fiber-reinforced resin-based composite sheet by the hot-press molding process.

In some embodiments, fibers of the fiber-reinforced resin-based composite sheet or the fiber-reinforced resin-based pre-preg tape of the first panel layer and/or the second panel layer are independently selected from the group consisting of glass fibers, carbon fibers, quartz fibers, high silica fibers, aluminum silicate fibers, mullite fibers, silicon carbide fibers, silicon nitride fibers, aluminum oxide fibers, boron nitride fibers, basalt fibers, brucite fibers, attapulgite fibers, boron fibers, carbon nanotubes, aramid fibers, polyimide fibers, and ultra-high molecular weight polyethylene fibers. The resin of the fiber-reinforced resin-based composite sheet or the fiber-reinforced resin-based pre-preg tape is selected from the group consisting of an epoxy resin, a phenolic resin, a benzoxazine resin, an unsaturated polyester resin, a vinyl ester resin, a silicon resin, and a cyanate resin.

In some embodiments, fibers of the fiber-reinforced aerogel felt are selected from the group consisting of glass fibers, carbon fibers, quartz fibers, high silica fibers, aluminum silicate fibers, mullite fibers, silicon carbide fibers, silicon nitride fibers, aluminum oxide fibers, boron nitride fibers, basalt fibers, brucite fibers, attapulgite fibers, boron fibers, carbon nanotubes, aramid fibers, polyimide fibers, and ultra-high molecular weight polyethylene fibers. The aerogel of the fiber-reinforced aerogel felt is selected from the group consisting of a silicon dioxide aerogel, a carbon aerogel, an aluminum oxide aerogel, a zirconium oxide aerogel, a titanium oxide aerogel, an iron oxide aerogel, a cobalt oxide aerogel, a nickel oxide aerogel, a copper oxide aerogel, a yttrium oxide aerogel, a cerium oxide aerogel, a vanadium oxide aerogel, a bismuth oxide aerogel, a tin oxide aerogel, a resorcinol formaldehyde aerogel, and a graphene aerogel.

In some embodiments, the liquid epoxy resin is selected from the group consisting of epoxy resin E51, epoxy resin E44, or a combination thereof.

In some embodiments, the heat insulation filler is selected from the group consisting of titanium dioxide particles, zinc oxide particles, hollow glass microbeads, hollow silicon dioxide microbeads, hollow phenolic resin microspheres, hollow ceramic microspheres, and a combination thereof.

In some embodiments, the curing agent is selected from the group consisting of imidazole, dicyandiamide, triethylene diamine, triethylene tetramine, and a combination thereof.

In some embodiments, the enhancer is selected from the group consisting of organic urea UR300 and organic urea UR500.

In some embodiments, the first coupling agent is a silane coupling agent.

In some embodiments, the aqueous elastic paint is selected from the group consisting of an aqueous ethylene-vinyl acetate elastic paint, an aqueous organosilicone-acrylate elastic paint, an aqueous acrylic elastic paint, and an aqueous rubber emulsion.

In some embodiments, the aqueous resin is selected from the group consisting of an aqueous epoxy resin, an aqueous polyurea resin, an aqueous phenolic resin, and an aqueous polyurethane resin.

In some embodiments,the flame retardant is selected from the group consisting of a phosphorus-nitrogen flame retardant, an inorganic flame retardant, DOPO, decabromodiphenyl ether, decabromodiphenyl ethane, and a combination thereof The inorganic flame retardant is selected from the group consisting of aluminum hydroxide, magnesium hydroxide, ammonium phosphate, and zinc borate. The phosphorus-nitrogen flame retardant is selected from the group consisting of ammonium polyphosphate, triphenyl isopropylated phosphate, melamine phosphate, melamine pyrophosphate, and melamine cyanurate.

In some embodiments, the dispersing agent is selected from the group consisting of BYK-161, BYK-163, and BYK-2000.

In some embodiments, the second coupling agent is selected from the group consisting of a silane coupling agent, a titanate coupling agent, an aluminate coupling agent, and a borate coupling agent.

In the present disclosure, the fiber-reinforced resin-based composite sheet, the fiber- reinforced resin-based pre-preg tape, or the fiber-reinforced aerogel felt is commercially available or can be prepared according to prior art.

The advantageous effects are as follows.

(1) In some embodiments of the present disclosure, the heat insulation and preservation layer and the panel layers are integrated by the hot-press molding process. Such a forming process is simple and easy to operate.

(2) In some embodiments of the present disclosure, the panel layer and the heat insulation and preservation layer can be integrated well by using the fiber-reinforced resin-based composite sheet as the panel layer and the fiber-reinforced aerogel felt as the heat insulation and preservation layer, which ensures the convenience in the transportation process and the mounting process of the heat insulation and preservation composite board as a whole. In addition, by using the fiber-reinforced resin-based composite sheet as the panel layer, the heat insulation and preservation composite board has an improved puncture resistance and relatively high strength and rigidity, and thus can be used as a structural member of a pipeline, a building wall, a vehicle, a box/cabinet, et al.

(3) In case that the panel layers are the fiber-reinforced resin-based composite sheets, in the making process of the heat insulation and preservation composite board, the first panel layer and the second panel layer before the hot-press process can adopt the fiber-reinforced resin-based pre-preg tapes which are the semi-finished products of the fiber-reinforced resin-based composite sheets. The fiber-reinforced resin-based pre-preg tape before the curing process is soft in whole and has a strong plasticity and a relatively long storage life. In addition, the curing process is simple and easy to operate. Therefore, for the heat insulation and preservation composite board which requires a long distance transportation, the fiber-reinforced aerogel felt and the fiber-reinforced resin-based pre-preg tape can be cured and molded at the using site to obtain the required heat insulation and preservation composite board, or the fiber-reinforced aerogel felt and the fiber-reinforced resin-based pre-preg tape can be pre-cured and then cured at the using site, so that the convenience and the flexibility of the heat insulation and preservation composite board in the transportation process can be improved.

(4) In some embodiments of the present disclosure, the heat insulation coating is directly coated on the surface of the fiber-reinforced aerogel felt to be used as the heat insulation and preservation layer. On one hand, the falling powder phenomenon of the fiber-reinforced aerogel felt in the use is prevented, and the safety performance of the heat insulation and preservation composite board is improved. On the other hand, the heat insulation coating has a relatively low density and good heat insulation and mechanical properties, which plays an important role in increasing the mechanical property of the fiber-reinforced aerogel felt without affecting the heat insulation property of the fiber-reinforced aerogel felt thereby ensuring the use efficiency of the fiber-reinforced aerogel felt. In addition, the use of the heat insulation coating has no influence on the transportation and mounting processes of the heat insulation and preservation composite board as a whole.

(5) In some embodiments of the present disclosure, the heat insulation coating is used as a joining phase to integrate the fiber-reinforced aerogel felt with the panel layer. The fiber-reinforced aerogel felt and the panel layer can be integrally formed well by the heat insulation coating in the curing and forming process due to the viscosity of the resin slurry, so that a good adhesion between the fiber-reinforced aerogel felt and the panel layer can be ensured, thereby preventing the detachment of the panel layer from the fiber-reinforced aerogel felt.

(6) In some embodiments of the present disclosure, the aluminum foil is wrapped on the surfaces of the fiber-reinforced aerogel felt, so that the heat transferred from the first panel can be directly reflected by the aluminum foil. Furthermore, the remaining heat not insulated by the fiber-reinforced aerogel felt will undergo a process such as reflecting-insulating-reflecting, so that finally only few heat can arrive at the second panel layer, thereby improving the heat insulation efficiency and further decreasing the temperature in a space.

(7) A heat preservation scheme using the heat insulation and preservation composite board provided in the present disclosure can be applied to scenes such as pipelines, building walls, and boxes, which has the advantages of easy operation and simple implementation.

### DETAILED DESCRIPTION

The present disclosure will now be described in detail with reference to the specific examples. It should be understood that the following examples are only for illustrating the present disclosure, and not intended to limit the scope of the present disclosure.

### Example 1

A heat insulation and preservation composite board includes a first panel layer and a heat insulation and preservation layer. The heat insulation and preservation layer and the first panel layer are integrally formed. The first panel layer is a glass-fiber-reinforced epoxy-resin-based composite sheet. The heat insulation and preservation layer is a glass-fiber-reinforced silicon dioxide aerogel felt.

A method for preparing the heat insulation and preservation composite board includes:

(1) laying the glass-fiber-reinforced silicon dioxide aerogel felt flat;

(2) laying a glass-fiber-reinforced epoxy-resin-based pre-preg tape corresponding to the first panel layer flat on an upper surface of the glass-fiber-reinforced silicon dioxide aerogel felt flat; and

(3) performing a hot-press molding process at a temperature of 140° C. and a pressure of 2 MPa, thereby obtaining the heat insulation and preservation composite board.

### Example 2

A heat insulation and preservation composite board includes a first panel layer and a heat insulation and preservation layer. The heat insulation and preservation layer and the first panel layer are integrally formed. The first panel layer is a glass-fiber-reinforced epoxy-resin-based composite sheet. The heat insulation and preservation layer is a glass-fiber-reinforced silicon dioxide aerogel felt.

A method for preparing the heat insulation and preservation composite board includes:

(1) laying the glass-fiber-reinforced silicon dioxide aerogel felt flat;

(2) laying the glass-fiber-reinforced epoxy-resin-based composite sheet as the first panel layer flat on an upper surface of the glass-fiber-reinforced silicon dioxide aerogel felt, and attaching a double faced adhesive tape onto the surface of the glass-fiber-reinforced silicon dioxide aerogel felt which is in contact with the glass-fiber-reinforced epoxy-resin-based composite sheet so as to bond them; and

(3) performing a hot-press molding process at a temperature of 60° C. and a pressure of 0.5 Mpa, thereby obtaining the heat insulation and preservation composite board.

### Example 3

A heat insulation and preservation composite board includes a first panel layer and a heat insulation and preservation layer. The heat insulation and preservation layer and the first panel layer are integrally formed. The first panel layer is a cabon-fiber-reinforced phenolic-resin-based composite sheet. The heat insulation and preservation layer is an aluminum-silicate-fiber-reinforced silicon dioxide aerogel felt.

A method for preparing the heat insulation and preservation composite board includes:

(1) laying the aluminum-silicate-fiber-reinforced silicon dioxide aerogel felt flat, mixing an aqueous elastic paint, an aqueous resin, a flame retardant, silicon dioxide powder, a dispersing agent, and a second coupling agent in a mass ratio of 40:20:3:15:1:2 by stirring at a high speed to obtain a heat insulation slurry, and then coating the heat insulation slurry uniformly onto an upper surface of the aluminum-silicate-fiber-reinforced silicon dioxide aerogel felt; the aqueous elastic paint is an aqueous ethylene-vinyl acetate elastic paint, the aqueous resin is an aqueous epoxy resin, the flame retardant is ammonium polyphosphate, the dispersing agent is BYK-161, and the second coupling agent is a silane coupling agent;

(2) laying the cabon-fiber-reinforced phenolic-resin-based composite sheet as the first panel layer flat on the upper surface of the aluminum-silicate-fiber-reinforced silicon dioxide aerogel felt which is coated with the heat insulation slurry; and

(3) performing a hot-press molding process at a temperature of 120° C. and a pressure of 1.5 MPa, thereby obtaining the heat insulation and preservation composite board.

### Example 4

A heat insulation and preservation composite board includes a first panel layer, a heat insulation and preservation layer, and a second panel layer. The heat insulation and preservation layer is located between the first panel layer and the second panel layer. The heat insulation and preservation layer and the first panel layer are integrally formed, and the heat insulation and preservation layer and the second panel layer are integrally formed. The first panel layer is a metal plate. The second panel layer is a glass-fiber-reinforced unsaturated-polyester-based composite sheet. The heat insulation and preservation layer is a glass-fiber-reinforced silicon dioxide aerogel felt.

A method for preparing the heat insulation and preservation composite board includes:

(1) laying the glass-fiber-reinforced silicon dioxide aerogel felt flat;

(2) laying the metal plate as the first panel layer and the glass-fiber-reinforced unsaturated-polyester-based composite sheet as the second panel layer flat on an upper surface and a lower surface of the glass-fiber-reinforced silicon dioxide aerogel felt, respectively, wherein a double faced adhesive tape is attached to each of the upper surface and the lower surface of the glass-fiber-reinforced silicon dioxide aerogel felt, so that the glass-fiber-reinforced silicon dioxide aerogel felt is bound to the metal plate as the first panel layer and to the glass-fiber-reinforced unsaturated-polyester-based composite sheet as the second panel layer; and

(3) performing a hot-press molding process at a temperature of 50° C. and a pressure of 4 MPa, thereby obtaining the heat insulation and preservation composite board.

### Example 5

A heat insulation and preservation composite board includes a first panel layer and a heat insulation and preservation layer. The heat insulation and preservation layer and the first panel layer are integrally formed. The first panel layer is an aramid-fiber-reinforced epoxy-resin-based composite sheet. The heat insulation and preservation layer is a mullite-fiber-reinforced zirconium oxide aerogel felt. A surface of the mullite-fiber-reinforced zirconium oxide aerogel felt which is in contact with the first panel layer is coated with a heat insulation coating.

A method for preparing the heat insulation and preservation composite board includes:

(1) laying the mullite-fiber-reinforced zirconium oxide aerogel felt flat, mixing an liquid epoxy resin, a heat insulation filler, a curing agent, an enhancer, and a first coupling agent in a mass ratio of 100:20:50:0.1:1 by stirring at a high speed to obtain a heat insulation slurry, and then coating the heat insulation slurry uniformly onto an upper surface of the mullite-fiber-reinforced zirconium oxide aerogel felt; the liquid epoxy resin is epoxy resin E51, the heat insulation filler is hollow glass microbeads, the curing agent is dicyandiamide, the enhancer is organic urea UR300, and the first coupling agent is a silane coupling agent;

(2) laying the aramid-fiber-reinforced epoxy-resin-based composite sheet as the first panel layer flat on the upper surface of the mullite-fiber-reinforced zirconium oxide aerogel felt which is coated with the heat insulation slurry; and

(3) performing a hot-press molding process at a temperature of 100° C. and a pressure of 2 MPa, thereby obtaining the heat insulation and preservation composite board.

### Example 6

A heat insulation and preservation composite board includes a first panel layer, a heat insulation and preservation layer, and a second panel layer. The heat insulation and preservation layer is located between the first panel layer and the second panel layer. The heat insulation and preservation layer and the first panel layer are integrally formed, and the heat insulation and preservation layer and the second panel layer are integrally formed. The first panel layer is a calcium silicate plate. The second panel layer is a quartz-fiber-reinforced vinyl-ester-resin-based composite sheet. The heat insulation and preservation layer is a glass-fiber-reinforced aluminum oxide aerogel felt. The surfaces of the glass-fiber-reinforced aluminum oxide aerogel felt which are in contact with the first panel layer and the second panel layer are coated with heat insulation coatings.

A method for preparing the heat insulation and preservation composite board includes:

(1) laying the glass-fiber-reinforced aluminum oxide aerogel felt flat, mixing an liquid epoxy resin, a heat insulation filler, a curing agent, an enhancer, and a first coupling agent in a mass ratio of 100:40:80:2:3 by stirring at a high speed to obtain a heat insulation slurry, and then coating the heat insulation slurry uniformly onto an upper surface and a lower surface of the glass-fiber-reinforced aluminum oxide aerogel felt; the liquid epoxy resin is epoxy resin E44, the heat insulation filler is hollow ceramic microspheres, the curing agent is triethylene diamine, the enhancer is organic urea UR500, and the first coupling agent is a silane coupling agent;

(2) laying the calcium silicate plate as the first panel layer and the quartz-fiber-reinforced vinyl-ester-resin-based composite sheet as the second panel layer flat on the upper surface and the lower surface of the glass-fiber-reinforced aluminum oxide aerogel felt which are coated with the heat insulation slurry, respectively; and

(3) performing a hot-press molding process at a temperature of 110° C. and a pressure of 3 MPa, thereby obtaining the heat insulation and preservation composite board.

### Example 7

A heat insulation and preservation composite board includes a first panel layer and a heat insulation and preservation layer. The heat insulation and preservation layer and the first panel layer are integrally formed. The first panel layer is an aluminum-oxide-fiber-reinforced cyanate-resin-based composite sheet. The heat insulation and preservation layer is a high-silica-fiber-reinforced titanium oxide aerogel felt. A surface of the high-silica-fiber-reinforced titanium oxide aerogel felt which is in contact with the first panel layer is coated with a heat insulation coating.

A method for preparing the heat insulation and preservation composite board includes:

(1) laying the high-silica-fiber-reinforced titanium oxide aerogel felt flat, mixing an aqueous elastic paint, an aqueous resin, a flame retardant, silicon dioxide powder, a dispersing agent, and a second coupling agent in a mass ratio of 50:25:4:35:3:4 by stirring at a high speed to obtain a heat insulation slurry, and then coating the heat insulation slurry uniformly onto an upper surface of the high-silica-fiber-reinforced titanium oxide aerogel felt; the aqueous elastic paint is an aqueous acrylic elastic paint, the aqueous resin is an aqueous phenolic resin, the flame retardant is magnesium hydroxide, the dispersing agent is BYK-2000, and the second coupling agent is a titanate coupling agent;

(2) laying the aluminum-oxide-fiber-reinforced cyanate-resin-based composite sheet as the first panel layer flat on the upper surface of the high-silica-fiber-reinforced titanium oxide aerogel felt which is coated with the heat insulation slurry; and

(3) performing a hot-press molding process at a temperature of 100° C. and a pressure of 0.5 MPa, thereby obtaining the heat insulation and preservation composite board.

### Example 8

A heat insulation and preservation composite board includes a first panel layer, a heat insulation and preservation layer, and a second panel layer. The heat insulation and preservation layer is located between the first panel layer and the second panel layer. The heat insulation and preservation layer and the first panel layer are integrally formed, and the heat insulation and preservation layer and the second panel layer are integrally formed. The first panel layer is a cement plate. The second panel layer is a quartz-fiber-reinforced phenolic-resin-based composite sheet. The heat insulation and preservation layer is a boron-fiber-reinforced graphene aerogel felt. The surfaces of the boron-fiber-reinforced graphene aerogel felt which are in contact with the first panel layer and the second panel layer are coated with heat insulation coatings.

A method for preparing the heat insulation and preservation composite board includes:

(1) laying the boron-fiber-reinforced graphene aerogel felt flat, mixing an aqueous elastic paint, an aqueous resin, a flame retardant, silicon dioxide powder, a dispersing agent, and a second coupling agent in a mass ratio of 55:30:5:40:3:5 by stirring at a high speed to obtain a heat insulation slurry, and then coating the heat insulation slurry uniformly onto an upper surface and a lower surface of the boron-fiber-reinforced graphene aerogel felt; the aqueous elastic paint is an aqueous rubber emulsion, the aqueous resin is an aqueous polyurethane resin, the flame retardant is DOPO, the dispersing agent is BYK-161, and the second coupling agent is a borate coupling agent;

(2) laying the cement plate as the first panel layer and the quartz-fiber-reinforced phenolic-resin-based composite sheet as the second panel layer flat on the upper surface and the lower surface of the boron-fiber-reinforced graphene aerogel felt which are coated with the heat insulation slurry, respectively; and

(3) performing a hot-press molding process at a temperature of 110° C. and a pressure of 1 MPa, thereby obtaining the heat insulation and preservation composite board.

### Example 9

A heat insulation and preservation composite board includes a first panel layer, a heat insulation and preservation layer, and a second panel layer. The heat insulation and preservation layer is located between the first panel layer and the second panel layer. The heat insulation and preservation layer and the first panel layer are integrally formed, and the heat insulation and preservation layer and the second panel layer are integrally formed. The first panel layer is a glass-fiber-reinforced cyanate-resin-based composite sheet. The second panel layer is a glass-fiber-reinforced epoxy-resin-based composite sheet. The heat insulation and preservation layer is a glass-fiber-reinforced graphene aerogel felt. The surfaces of the glass-fiber-reinforced graphene aerogel felt which are in contact with the first panel layer and the second panel layer are coated with heat insulation coatings. After being coated with the heat insulation coatings, the glass-fiber-reinforced graphene aerogel felt is externally wrapped by an aluminum foil. A bonding agent is provided between the aluminum foil and the first panel layer and between the aluminum foil and the second panel layer.

A method for preparing the heat insulation and preservation composite board includes:

(1) laying the glass-fiber-reinforced graphene aerogel felt flat, mixing an liquid epoxy resin, a heat insulation filler, a curing agent, an enhancer, and a first coupling agent in a mass ratio of 100:20:90:2:3 by stirring at a high speed to obtain a heat insulation slurry, and then coating the heat insulation slurry uniformly onto an upper surface and a lower surface of the glass-fiber-reinforced graphene aerogel felt, and wrapping the aluminum foil around the glass-fiber-reinforced graphene aerogel felt after the glass-fiber-reinforced graphene aerogel felt is coated with the heat insulation slurry, applying the bonding agent on each of an upper surface and a lower surface of the aluminum foil; the liquid epoxy resin is epoxy resin E51, the heat insulation filler is zinc oxide particles, the curing agent is triethylene tetramine, the enhancer is organic urea UR500, and the first coupling agent is a silane coupling agent; and

(2) laying the glass-fiber-reinforced cyanate-resin-based composite sheet as the first panel layer and the glass-fiber-reinforced epoxy-resin-based composite sheet as the second panel layer flat on the upper surface and the lower surface of the glass-fiber-reinforced graphene aerogel felt which is wrapped by the aluminum foil, respectively;

(3) performing a hot-press molding process at a temperature of 150° C. and a pressure of 5 MPa, thereby obtaining the heat insulation and preservation composite board.

### Example 10

A heat insulation and preservation composite board includes a first panel layer, a heat insulation and preservation layer, and a second panel layer. The heat insulation and preservation layer is located between the first panel layer and the second panel layer. The heat insulation and preservation layer and the first panel layer are integrally formed, and the heat insulation and preservation layer and the second panel layer are integrally formed. The first panel layer is a metal plate. The second panel layer is a glass-fiber-reinforced epoxy-resin-based composite sheet. The heat insulation and preservation layer is a carbon-fiber-reinforced silicon dioxide aerogel felt. The surfaces of the carbon-fiber-reinforced silicon dioxide aerogel felt which are in contact with the first panel layer and the second panel layer are coated with heat insulation coatings. After being coated with the heat insulation coatings, the carbon-fiber-reinforced silicon dioxide aerogel felt is externally wrapped by an aluminum foil. A bonding agent is provided between the aluminum foil and the first panel layer and between the aluminum foil and the second panel layer.

A method for preparing the heat insulation and preservation composite board includes:

(1) laying the carbon-fiber-reinforced silicon dioxide aerogel felt flat, mixing an aqueous elastic paint, an aqueous resin, a flame retardant, silicon dioxide powder, a dispersing agent, and a second coupling agent in a mass ratio of 65:25:2:30:4:3 by stirring at a high speed to obtain a heat insulation slurry, and then coating the heat insulation slurry uniformly onto an upper surface and a lower surface of the carbon-fiber-reinforced silicon dioxide aerogel felt, and wrapping the aluminum foil around the carbon-fiber-reinforced silicon dioxide aerogel felt after the carbon-fiber-reinforced silicon dioxide aerogel felt is coated with the heat insulation slurry, applying the bonding agent on each of an upper surface and a lower surface of the aluminum foil; the aqueous elastic paint is an aqueous ethylene-vinyl acetate elastic paint, the aqueous resin is an aqueous epoxy resin, the flame retardant is decabromodiphenyl ether, the dispersing agent is BYK-163, and the second coupling agent is a silane coupling agent;

(2) laying the metal plate as the first panel layer and the glass-fiber-reinforced epoxy-resin-based composite sheet as the second panel layer flat on the upper surface and the lower surface of the fiber-reinforced aerogel felt which is wrapped by the aluminum foil, respectively; and

(3) performing a hot-press molding process at a temperature of 115° C. and a pressure of 2.5 MPa, thereby obtaining the heat insulation and preservation composite board.

1. A heat insulation and preservation composite board, comprising a first panel layer and a heat insulation and preservation layer, wherein the heat insulation and preservation layer and the first panel layer are integrally formed; the first panel layer is selected from the group consisting of a fiber-reinforced resin-based composite sheet, a metal plate, a cement plate, a calcium silicate plate, and a gypsum plate; and the heat insulation and preservation layer is a fiber-reinforced aerogel felt;
in a case that the first panel layer is the fiber-reinforced resin-based composite sheet, a surface of the fiber-reinforced aerogel felt which is in contact with the first panel layer is coated or uncoated with a heat insulation coating;
in a case that the first panel layer is selected from the group consisting of the metal plate, the cement plate, the calcium silicate plate, and the gypsum plate, the surface of the fiber-reinforced aerogel felt which is in contact with the first panel layer is coated with the heat insulation coating;
the heat insulation coating consists of a liquid epoxy resin, a heat insulation filler, a curing agent, an enhancer, and a first coupling agent in a mass ratio of 100:(10-50):(20-180):(0.05-3):(0.2-5), or the heat insulation coating consists of an aqueous elastic paint, an aqueous resin, a flame retardant, silicon dioxide powder, a dispersing agent, and a second coupling agent in a mass ratio of (30-60):(10-30):(2-5):(5-40):(0.5-5):(1-5).

2. The heat insulation and preservation composite board of claim 1, further comprising a second panel layer, wherein the heat insulation and preservation layer is located between the first panel layer and the second panel layer; the heat insulation and preservation layer and the second panel layer are also integrally formed; the second panel layer is an additional fiber-reinforced resin-based composite sheet, and the surface of the fiber-reinforced aerogel felt which is in contact with the first panel layer and another surface of the fiber-reinforced aerogel felt which is in contact with the second panel layer are each coated or uncoated with the heat insulation coating.

3. The heat insulation and preservation composite board of claim 2, wherein in a case that the fiber-reinforced aerogel felt is uncoated with the heat insulation coating, the fiber-reinforced aerogel felt is externally and directly wrapped by an aluminum foil; in a case that the fiber-reinforced aerogel felt is coated with the heat insulation coating, the fiber-reinforced aerogel felt is externally wrapped by the aluminum foil after being coated with the heat insulation coating; and a bonding agent or a double faced adhesive tape is provided between the aluminum foil and the first panel layer or between the aluminum foil and the second panel layer.

4. The heat insulation and preservation composite board of claim 1, wherein the heat insulation coating is replaced by a double faced adhesive tape.

5. The heat insulation and preservation composite board of claim 1, wherein
fibers of the fiber-reinforced resin-based composite sheet are selected from the group consisting of glass fibers, carbon fibers, quartz fibers, high silica fibers, aluminum silicate fibers, mullite fibers, silicon carbide fibers, silicon nitride fibers, aluminum oxide fibers, boron nitride fibers, basalt fibers, brucite fibers, attapulgite fibers, boron fibers, carbon nanotubes, aramid fibers, polyimide fibers, and ultra-high molecular weight polyethylene fibers, and a resin of the fiber-reinforced resin-based composite sheet is selected from the group consisting of an epoxy resin, a phenolic resin, a benzoxazine resin, an unsaturated polyester, a vinyl ester resin, a silicon resin, and a cyanate resin.

6. A method for preparing the heat insulation and preservation composite board of claim 1, comprising:
(1) laying the fiber-reinforced aerogel felt flat;
(2) laying the first panel layer flat on the surface of the fiber-reinforced aerogel felt to be in contact with the first panel layer; in a case that the first panel layer is the fiber-reinforced resin-based composite sheet, and that the surface of the fiber-reinforced aerogel felt to be in contact with the first panel layer is coated with the heat insulation coating, the first panel layer in this step is directly the fiber-reinforced resin-based composite sheet or is replaced by a fiber-reinforced resin-based pre-preg tape corresponding to the fiber-reinforced resin-based composite sheet; in a case that the first panel layer is the fiber-reinforced resin-based composite sheet, and that the surface of the fiber-reinforced aerogel felt to be in contact with the first panel layer is uncoated with the heat insulation coating, the first panel layer in this step is replaced by a fiber-reinforced resin-based pre-preg tape corresponding to the fiber-reinforced resin-based composite sheet;
(3) performing a hot-press molding process to obtain the heat insulation and preservation composite board.

7. The method of claim 6, wherein the heat insulation and preservation composite board further comprises a second panel layer; the heat insulation and preservation layer is located between the first panel layer and the second panel layer; the heat insulation and preservation layer and the second panel layer are also integrally formed; the second panel layer is an additional fiber-reinforced resin-based composite sheet; the surface of the fiber-reinforced aerogel felt which is in contact with the first panel layer and another surface of the fiber-reinforced aerogel felt which is in contact with the second panel layer are each coated or uncoated with the heat insulation coating; and the corresponding step (2) comprises: laying the first panel layer and the second panel layer flat on the surfaces of the fiber-reinforced aerogel felt to be in contact therewith, respectively; in a case that the first panel layer and the second panel layer are the fiber-reinforced resin-based composite sheets, and that the surfaces of the fiber-reinforced aerogel felt to be respectively in contact with the first panel layer and the second panel layer are each coated with the heat insulation coating, the first panel layer and the second panel layer in this step are directly the fiber-reinforced resin-based composite sheets or are replaced by fiber-reinforced resin-based pre-preg tapes corresponding to the fiber-reinforced resin-based composite sheets; in a case that the first panel layer and the second panel layer are the fiber-reinforced resin-based composite sheets, and that the surfaces of the fiber-reinforced aerogel felt to be respectively in contact with the first panel layer and the second panel layer are each uncoated with the heat insulation coating, the first panel layer and the second panel layer in this step are replaced by fiber-reinforced resin-based pre-preg tapes corresponding to the fiber-reinforced resin-based composite sheets; and in a case that the first panel layer is the metal plate, the cement plate, the calcium silicate plate, or the gypsum plate, that the second panel layer is the fiber-reinforced resin-based composite sheet, and that the surfaces of the fiber-reinforced aerogel felt to be respectively in contact with the first panel layer and the second panel layer are each coated with the heat insulation coating, the second panel layer in this step is directly the additional fiber-reinforced resin-based composite sheet or is replaced by the fiber-reinforced resin-based pre-preg tape corresponding to the additional fiber-reinforced resin-based composite sheet.

8. The method of claim 6, wherein the fiber-reinforced aerogel felt is externally and directly wrapped by an aluminum foil in a case that the fiber-reinforced aerogel felt is uncoated with the heat insulation coating; the fiber-reinforced aerogel felt is externally wrapped by an aluminum foil after being coated with the heat insulation coating in a case that the fiber-reinforced aerogel felt is coated with the heat insulation coating.

9. The method of claim 6, wherein the heat insulation coating is replaced by a double faced adhesive tape.

10. The method of claim 6, wherein a temperature of the hot-press molding process is 50° C. to 150° C. and a pressure of the hot-press molding process is 0.5 MPa to 5 MPa.

11. The heat insulation and preservation composite board of claim 1, wherein fibers of the fiber-reinforced aerogel felt are selected from the group consisting of glass fibers, carbon fibers, quartz fibers, high silica fibers, aluminum silicate fibers, mullite fibers, silicon carbide fibers, silicon nitride fibers, aluminum oxide fibers, boron nitride fibers, basalt fibers, brucite fibers, attapulgite fibers, boron fibers, carbon nanotubes, aramid fibers, polyimide fibers, and ultra-high molecular weight polyethylene fibers; and an aerogel of the fiber-reinforced aerogel felt is selected from the group consisting of a silicon dioxide aerogel, a carbon aerogel, an aluminum oxide aerogel, a zirconium oxide aerogel, a titanium oxide aerogel, an iron oxide aerogel, a cobalt oxide aerogel, a nickel oxide aerogel, a copper oxide aerogel, a yttrium oxide aerogel, a cerium oxide aerogel, a vanadium oxide aerogel, a bismuth oxide aerogel, a tin oxide aerogel, a resorcinol formaldehyde aerogel, and a graphene aerogel.

12. The heat insulation and preservation composite board of claim 1, wherein the liquid epoxy resin is selected from the group consisting of epoxy resin E51, epoxy resin E44, and a combination thereof.

13. The heat insulation and preservation composite board of claim 1, wherein the heat insulation filler is selected from the group consisting of titanium dioxide particles, zinc oxide particles, hollow glass microbeads, hollow silicon dioxide microbeads, hollow phenolic resin microspheres, hollow ceramic microspheres, and a combination thereof.

14. The heat insulation and preservation composite board of claim 1, wherein the curing agent is selected from the group consisting of imidazole, dicyandiamide, triethylene diamine, triethylene tetramine, and a combination thereof.

15. The heat insulation and preservation composite board of claim 1, wherein the enhancer is selected from the group consisting of organic urea UR300 and organic urea UR500.

16. The heat insulation and preservation composite board of claim 1, wherein the first coupling agent is a silane coupling agent.

17. The heat insulation and preservation composite board of claim 1, wherein the aqueous elastic paint is selected from the group consisting of an aqueous ethylene-vinyl acetate elastic paint, an aqueous organosilicone-acrylate elastic paint, an aqueous acrylic elastic paint, and an aqueous rubber emulsion, and the aqueous resin is selected from the group consisting of an aqueous epoxy resin, an aqueous polyurea resin, an aqueous phenolic resin, and an aqueous polyurethane resin.

18. The heat insulation and preservation composite board of claim 1, wherein the flame retardant is selected from the group consisting of a phosphorus-nitrogen flame retardant, an inorganic flame retardant, DOPO, decabromodiphenyl ether, decabromodiphenyl ethane, and a combination thereof.

19. The heat insulation and preservation composite board of claim 1, wherein the dispersing agent is selected from the group consisting of BYK-161, BYK-163, and BYK-2000.

20. The heat insulation and preservation composite board of claim 1, wherein the second coupling agent is selected from the group consisting of a silane coupling agent, a titanate coupling agent, an aluminate coupling agent, and a borate coupling agent.
